(19) United States
(12) Patent Application Publication
(10) Pub. No.: US 2025/0307921 A1
(43) Pub. Date: Oct. 2, 2025

(54) System and Methods for Automated Data Validation and Risk Bias Prediction

(71) Applicant: TRAiNED, Inc., Pittsburgh, PA (US)

(72) Inventors: Jonathan Freed, Bridgeville, PA (US); David John Paulina, Jr., McMurray, PA (US); Kyle Scott W Jenkins, New Kensington, PA (US); George Salvatore Goehring, Coraopolis, PA (US); Nicholas J Goossen, Moon Township, PA (US); Joseph Arthur Friedman, Pittsburgh, PA (US); Jason Scott Overand, Pittsburgh, PA (US); Christina Soukhamneut, Savannah, GA (US); Janet Louise Wilson, Morton, PA (US); Jennifer Ann Auvinen, Winnemucca, NV (US)

(21) Appl. No.: 19/236,908

(22) Filed: Jun. 12, 2025

Related U.S. Application Data
(63) Continuation-in-part of application No. 18/337,350, filed on Jun. 19, 2023.
(60) Provisional application No. 63/501,658, filed on May 11, 2023.

(51) Int. Cl. G06Q 40/03; G06N 3/0464; G06N 3/08

(52) U.S. Cl. CPC G06Q 40/03; G06N 3/0464; G06N 3/08

(57) ABSTRACT

A platform which provides a system and method for intelligent document processing with anomaly detection and predictive analysis comprising a user interface which allows platform users to upload documents, a data acquisition engine that leverages one or more machine and/or deep learning algorithms to classify, validate, and enforce compliance of the uploaded documents, and an artificial intelligence engine that constructs and maintains the models developed from the machine and/or deep learning algorithms. The platform may utilize various bespoke APIs to integrate validated data with third-party systems when an authorized entity initiates the process. The platform can function as a system of record and central, secure repository for an applicant's documentation and information required for various application processes. In some embodiments, the platform utilizes a trained generative AI model to assist platform users and to provide predictive analysis responsive to user submitted queries.

### CROSS REFERENCE TO RELATED APPLICATIONS

Priority is claimed in the application data sheet to the following patents or patent applications, each of which is expressly incorporated herein by reference in its entirety:
Ser. No. 18/337,350
63/501,658

### BACKGROUND OF THE INVENTION

### Field of the Art

The present invention is in the field of automated document processing and validation systems, and more particularly in the field of intelligent document classification and anomaly detection.

### Discussion of the State of the Art

Organizations that process applications (i.e., decision-making entities) may utilize document management systems which act as repositories for documentation and information required from applicants. Each organization may operate different systems with their own formatting protocols and validation requirements. An applicant must upload numerous documents including personal information, professional credentials, financial records, and other supporting materials when submitting an application. A prudent applicant will often apply to multiple organizations to maximize their opportunities. Currently, an applicant must provide all documentation repeatedly for each organization they choose to engage with. This is frustrating to the applicant at best and is time consuming for each organization to validate each document and the information contained therein. Furthermore, organizations may possess hidden biases that can adversely affect certain applicants based on demographic data, location data, or other characteristics.

What is needed is a system and method for automated document validation and bias detection in decision-making processes which overcomes the limitations of the existing art.

### SUMMARY OF THE INVENTION

Accordingly, the inventor has conceived and reduced to practice, a platform which provides a system and method for loan origination data validation and predictive analysis comprising a user interface which allows platform users to upload data, a data acquisition engine that leverages one or more machine and/or deep learning algorithms to classify, validate, and enforce compliance of the uploaded data, and an artificial intelligence engine that constructs and maintains the models developed from the machine and/or deep learning algorithms. The platform may utilize various bespoke APIs to integrate validated data with lender institution loan origination systems when a lender initiates the process. The platform can function as a system of record and central, secure repository for a borrower's documentation and information required to apply for a loan. In some embodiments, the platform utilizes a trained generative AI model to assist platform users and to provide predictive analysis responsive to user submitted queries.

According to a preferred embodiment, a system for loan origination data validation and predictive analysis, comprising: a computing device comprising a memory and a processor; a data acquisition engine comprising a first plurality of programming instructions stored in the memory which, when operating on the processor, causes the computing device to: receive one or more documents associated with a borrower; feed the one or more documents into a first machine learning model comprising a convolutional neural network configured to: normalize documents of varying dimensions using adaptive pooling; extract multi-scale features through multiple convolutional layers; apply a spatial attention mechanism to identify and weight document regions containing financial data fields; and output document classification and associated confidence scores; feed each of the one or more documents and its classification into a second machine learning model configured to validate the data by: extracting data fields using classification-specific parsing patterns; detecting anomalous values using a trained autoencoder that compares reconstruction error against learned thresholds; performing cross-document verification by mapping relationships between related financial fields; and generating field-level validation confidence scores; store the validated data and confidence scores in a borrower profile; and a generative artificial intelligence model configured to: receive as input a query and the borrower profile including the validation confidence scores; and generate predictive responses to the query weighted by the validation confidence scores.

According to another preferred embodiment, a method for loan origination data validation and predictive analysis, comprising the steps of: receiving one or more documents associated with a borrower; normalizing documents of varying dimensions using adaptive pooling; extracting multi-scale features through multiple convolutional layers; applying a spatial attention mechanism to identify and weight document regions containing financial data fields; outputting document classification and associated confidence scores;
extracting data fields using classification-specific parsing patterns; detecting anomalous values using a trained autoencoder that compares reconstruction error against learned thresholds; performing cross-document verification by mapping relationships between related financial fields; generating field-level validation confidence scores; storing the validated data and confidence scores in a borrower profile; receiving as input a query and the borrower profile including the validation confidence scores; and generating predictive responses to the query weighted by the validation confidence scores.

According to an aspect of an embodiment, the first machine learning model is a trained classifier network.

According to an aspect of an embodiment, the second machine learning model is trained using a regression algorithm.

According to an aspect of an embodiment, the data acquisition engine is further configured to: retrieve one or more compliance rules; and transform the validated data to enforce compliance with the one or more compliance rules.

According to an aspect of an embodiment, the borrower profile comprise one or more access rules define one or more lender institutions which the borrower has authorized to the data in the borrower profile.

According to an aspect of an embodiment, an application programming interface comprising a second plurality of programming instructions stored in the memory which, when operating on the processor, causes the computing device to: transmit the validated data in the borrower profile to a loan origination system associated with the one or more authorized lender institutions.

### BRIEF DESCRIPTION OF THE DRAWING FIGURES

FIG. 1 is a block diagram illustrating an exemplary system architecture for a loan origination data validation and risk bias prediction platform, according to one aspect.

FIG. 2 is a block diagram illustrating an exemplary data that may be stored in one or more databases, according to an embodiment.

FIG. 3 is a block diagram illustrating an exemplary aspect of a platform for loan origination data validation and predictive analysis, a data acquisition engine.

FIG. 4 is a block diagram illustrating an exemplary aspect of a platform for loan origination data validation and predictive analysis, an artificial intelligence engine.

FIG. 5 is a flow diagram illustrating an exemplary method for training a document classifier network, according to an embodiment.

FIG. 6 is a flow diagram illustrating an exemplary method for training a machine learning regression algorithm to make predictions related to risk bias, according to an embodiment.

FIG. 7 is a flow diagram illustrating an exemplary process for implementing rules-based text and data validation model, according to an embodiment.

FIG. 8 is a flow diagram illustrating an exemplary method for processing uploaded data into user profiles, according to one aspect.

FIG. 9 is a flow diagram illustrating an exemplary method for generating prediction associated with loan origination utilizing generative AI, according to one aspect.

FIG. 10 is a block diagram illustrating an exemplary architecture of a document classifier implementing CNN-based classification with spatial attention mechanisms, according to an embodiment.

FIG. 11 is a block diagram illustrating an exemplary architecture of a data validator implementing advanced validation techniques including autoencoder-based anomaly detection and cross-document verification, according to an embodiment.

FIG. 12 is a flow diagram illustrating an exemplary method for enhanced document classification and validation using CNN and autoencoder architectures, according to an embodiment.

FIG. 13 illustrates an exemplary computing environment on which an embodiment described herein may be implemented, in full or in part.

### DETAILED DESCRIPTION OF THE DRAWING FIGURES

The inventor has conceived, and reduced to practice, a platform which provides a system and method for loan origination data validation and predictive analysis comprising a user interface which allows platform users to upload data, a data acquisition engine that leverages one or more machine and/or deep learning algorithms to classify, validate, and enforce compliance of the uploaded data, and an artificial intelligence engine that constructs and maintains the models developed from the machine and/or deep learning algorithms. The platform may utilize various bespoke APIs to integrate validated data with lender institution loan origination systems when a lender initiates the process. The platform can function as a system of record and central, secure repository for a borrower's documentation and information required to apply for a loan. In some embodiments, the platform utilizes a trained generative AI model to assist platform users and to provide predictive analysis responsive to user submitted queries.

The system and methods discussed herein can provide automated processes enhanced with artificial intelligence to improve the user experience by providing a secure data repository with respect to mortgage origination. In a particular use case, either a lender or a borrower can provide the platform with the requisite documents and information necessary to originate a loan, wherein the platform provides, among other functions, automated data validation, compliance, and normalization of the provided information before the data is securely stored in a one or more databases and associated with the borrower. At this point, the platform has a repository of validated and compliant data which can be provided (with borrower consent) to one or more loan origination systems (LOS) associated with a mortgage company such as a bank or other type of lender using one or more bespoke APIs provided by the platform. Currently, each lender may use their own LOS and may require the borrower to submit the requisite documents and information necessary to start a loan application. The borrower must submit all this information to each different lender the borrower applies with. What's more, each different lender must also individually validate the borrower's information. The disclosed system provides utility to both borrowers and lenders because it allows borrowers/lenders to only have to upload the required documents and information only once and further provides borrowers with the control over who can receive that information, Lenders can benefit from the automated document and information validation and compliance and the easy integration of such information into their existing LOS via integrated APIs.

Furthermore, the platform leverages big data and machine learning to provide insight and analysis of data related to loans, borrowers, and lenders. In some implementations, a generative artificial intelligence model may be developed to provide analysis and assist users.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any particular order. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “lender” or “system user” as referred to herein represents any individual, group (public or private), or a financial institution which provides loan services directly to consumers. Lenders provide funds for a variety of reasons, such as a home mortgage, an automobile loan, or a small business loan.

The term “borrower” to herein represents an individual who accesses the platform to provide documentation and information associated with a loan application. Borrower's may interface with the platform to provide authentication and/or authorization when applicable.

### Conceptual Architecture

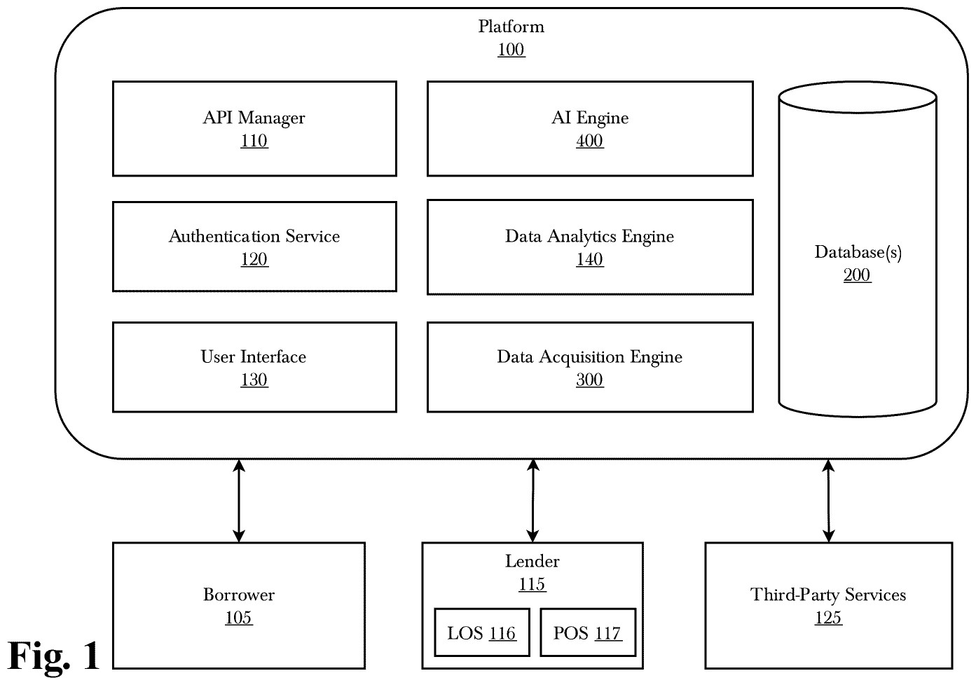

FIG. 1 is a block diagram illustrating an exemplary system architecture for a loan origination data validation and risk bias prediction platform 100, according to one aspect. According to various embodiments, platform 100 can be configured to receive a plurality of information associated with a platform user and provide automated data validation, data compliance, and data transformations on any received data, and which maintains data security and generates alerts to the platform user and/or enterprise. The platform can obtain data from users and/or directly from third-party services, and in some embodiments uses a generational artificial intelligence (AI) system configured to drive digital questions and technical interaction with the platform user based on the obtained information and provide insight and analysis, according to some embodiments. The AI may ask questions based on the obtained data, wherein the questions require documents to be gathered and uploaded or downloaded from third-party services. During the validation process data may be flagged that cannot be validated or may not be compliant with existing rules, and the AI may ask the user for more information or give suggestions to the user on how to address the flagged data in order for the data to be validated and/or verified compliant. Furthermore, in certain embodiments the generative AI model may be capable of generating media associated with loan application processing. For example, according to one embodiment, the generative AI may be used to generate potential mortgage offers based on input data and the underlying model. In such an embodiment, a borrower or lender may be able to upload to platform 100 whatever documentation and information they may currently possess and which is associated with information necessary to apply for a loan and the generative AI can generate an individually tailored mortgage loan estimate (e.g., including loan terms such as length, interest rate, amortization schedule, and/or the like) for the borrower using on the data provided. In some implementations, the generative AI may be configured to predict risk bias associated with a borrower and/or lender.

According to the embodiment, a platform can provide utility to borrowers who are preparing to secure a loan from a lender. The borrower may or may not be aware of the required documentation and information necessary to apply for a home loan. The borrower may already be in possession of all, a portion of, or none of the required documentation and information necessary to apply for a home loan. The borrower can access platform 100 via user interface 130 using a computing device of the borrower's own choosing and personal preference. For example, the borrower can access platform 100 using a mobile application stored and operating on his or her smart phone, or via a web application or website via an Internet connection, and/or the like.

Once the borrower has accessed platform 100 via UI 130 they may upload any of the required documents (e.g., pay stubs, W-2s, etc.) and information (e.g., contact information, credit report, etc.). Data uploaded to platform 100 by the borrower may be sent to a data acquisition engine 300 which can be configured to validate the borrower's data, verify the uploaded data is in compliance with various regulations and rules, and transform the data as necessary. In some implementations, data acquisition engine 300 may leverage one or more machine learning algorithms and/or models to facilitate one or more data validation processes. For example, a trained classifier network may be used to analyze and classify obtained documents. Once a document has been classified, data acquisition engine 300 can perform validation by scanning the document to identify certain data fields, determining if the data fields contain valid data, if the data is not valid generating an alert signal which can be communicated back to the borrower, loan origination system (LOS) 116, and/or point-of-sale (POS) 117, and securely storing the document in a database 200 when the entire document has been scanned. POS 117 may communicate and transmit data with platform 100 via APIs and/or via user interface 130. POS data may be sent to platform and validated and stored as described herein. Additionally, or alternatively, platform may communicate with lenders via the website/web app UI and/or standard messaging with a checklist, report, and summary statement. The UI 130 may display a message to the borrower informing the borrower that a document has been successfully upload and validated. The UI 130 may display a message to the borrower informing the borrower that a document has not been fully validated and the message may include more information such as, for example, the name of the document which could not be fully validated, the data fields which could not be validated, and in some embodiments, recommended corrections or suggestions of resources which the borrower can use to correct the unvalidated data. In some implementations, a process may be configured to handle invalid data: the platform identifies invalid data and informs the borrower/lender via the UI where the borrower/lender is allowed to correct the data, and then the platform publishes the updated data onto the appropriate LOS or intended recipient platform.

In some embodiments, data may be extracted from a borrower's document and transformed for data storage or data transmission. Platform is configured to receive documents of data in various formats including, but not limited to, comma separated variable (CSV), json, xml, pdf, doc, docx, html, htm, xls, and xlsx, to name a few. For example, as a document is being scanned and each validated data field and its associated data may be extracted and transformed into a comma-separated-variable (.CSV) file, encrypted, and then stored in database 200. In some implementations, data may be transformed based on business rules or logic associated with an enterprise. An enterprise may refer to a financial lender (e.g., a bank, a mortgage lender, etc.) or a to a financial lender's loan origination system (LOS). In this way, data may be transformed into a format that is easily transmittable and ready to efficiently integrate with enterprise systems and software based on business rules and logic set forth by the enterprise itself. For example, an enterprise rule may require that all names be all upper case lettering, or that numerical values must be represented as a double to the one-hundredth decimal, or that data must be encrypted according to a specific protocol, and/or the like. Furthermore, obtained data may be further checked for compliance with governmental rules and regulations such as, for example, the European general data protection regulation (GDPR) or the California Consumer Privacy Act (CCPA). Data acquisition engine 300 can verify that borrower data, which can include sensitive information such as personal identifying information (PII) or personal health information (PHI), is being processed and stored in compliance with all rules and regulations.

According to various embodiments, data acquisition engine 300 may validate data using machine learning. In one embodiment, a machine learning algorithm may be trained to produce a model that can perform data validation and assign a confidence score to the analyzed data, wherein the confidence score may be used to determine if the analyzed data is valid or not. Validation rules may be established and used when performing data validation. For example a validation rule for a document may state that the beginning balance plus/minus deposit/debit values should then calculate to the ending balance, or that pay stubs balance out, and/or the like. The confidence score may be a numerical value such as a number between 0 and 100 or any other arbitrary number range. Alternatively, or additionally, a confidence score could be represented using a color scheme such as green for high confidence that the data is valid, yellow for average confidence indicating that the borrower and/or lender should review the submitted information, and red for low confidence indicating and flagged for review.

In some implementations, platform may be configured to send validated data to a LOS associated with a lender via one or more application programming interfaces (APIs) which facilitate data exchange between enterprise LOS and platform. An API manager 110 may be present and configured to manage the execution and maintenance of a plurality of bespoke APIs. In some implementation's an API may be associated with a specific type of LOS or other enterprise software.

According to some embodiments, database(s) 200 may comprise one or more non-volatile data storage devices. Database(s) 200 may comprise one or more of the following systems, but is not limited to such systems, a centralized database, a distributed database, a NoSQL database, a cloud database, a relational database, a non-relational database, an object oriented database, hierarchical database, etc.

In some embodiments, data acquisition engine 300 may perform data encryption on obtained data prior to any validation, compliance, storage, or transformation actions occur. For example, platform 100 may utilize advanced encryption standard (AES) which uses “symmetric” key encryption and is well known to those with skill in the art. Furthermore, platform 100 may utilize one or more authentication schemes or mechanisms 120 for providing access to borrowers and lenders alike. For example, two-factor authentication (2FA) or two-step verification may be implemented in some embodiments to provide user verification and grant access to platform.

In some implementations, platform 100 may obtain data from one or more third-party sources 125. The obtained third-party data may be used as input into the generational AI and/or it may be validated and transformed, if applicable. For example, platform 100 may obtain data directly from the Internal Revenue Service (IRS) such as a borrower's W-2 and tax filing information. Furthermore, platform 100 may interface with United States government backed institutions such as Federal National Mortgage Association (FNMA) and/or Federal Home Loan Mortgage Corporation (Freddie) and provide them with the borrower's validated documents. In some implementations, platform may connect with Desktop Underwriter (FNMA) and/or Loan Processor (Freddie) to automatically upload validated documents.

The system may comprise a data acquisition engine 300 configured to receive data obtained from a borrower 105, a lender 115, and/or third-party services 125. The data acquisition engine 300 may receive data from the user interface 130, from API manager 110, and in some instances, directly from various third-party services and sources 125. Data acquisition engine 300 may receive borrower information and documents associated with applying for a loan. Some of the information and documents that may be obtained by platform 100 can include, but is not limited to, personal information (e.g., name, social security number, date of birth, address, phone number, email address, health information, etc.), employment and income information (e.g., current and previous employers, length of employment, and income documentation such as pay stubs, W-2s, and tax returns), assets and liabilities (e.g., bank statements, investment account statements, and information about any outstanding debts, etc.), credit history (e.g., credit score, credit reports, and information about any bankruptcies, foreclosures, and other credit issues, etc.), and property information (e.g., the address and purchase price of the home of interest, as well as information about any other real estate the borrower owns). Data acquisition engine 300 may utilize one or more machine learning algorithms to automatically validate obtained data as well as enforce compliance rules, best practices, guidelines, overlays, etc., if applicable, and provide data normalization.

The system may comprise an application programming interface (API) manager 110 configured to manage the deployment and maintenance of a plurality of bespoke APIs configured to integrate platform 100 with external third-party services 125, and/or a loan origination system (LOS) 116. API manager 110 is configured to control the ways in which the plurality of APIs are used within the platform 100 and by external systems. In some implementations, API manager 110 plays a part in designing, deploying, managing, and retiring APIs. The plurality of APIs can enable applications to communicate with each other and exchange information. They act as a gateway between applications and services, offering a set of defined rules which allow applications to communicate to each and share information. As a result, the APIs managed via API manager 110 make it easier for platform 100 to provide an interface with services and leverage third-party solutions where applicable. API manager 110 provides scalability and manages API integrations across an increasing number of systems and applications, whether they are on-premises, on the cloud, hybrid cloud, or multi-cloud. API manager 110 may deploy and reuse integration assets quickly, securely, and efficiently.

The platform 100 may comprise a user interface (UI) 130 which can provide a front-end user experience and interface for providing information and interacting with platform services. The UI 130 can provide a means for receiving user input (e.g., identification data, financial data, etc.) and displaying system output (e.g., system request for information, etc.). The output may be responsive to a user query or action, or based on an action or internal process of one or more platform services and/or components. In some implementations, the UI 130 is a graphical user interface (GUI). In some implementations, the UI 130 is a web-application accessible via an Internet connection on a suitable computing device (e.g., desktop computer, laptop, tablet computer, smart wearable, smart phone, etc.). In some implementations, the UI 130 is a software application operating on a borrower's mobile computing device such as, for example, a borrower's smart phone. The UI 130 may interact with other platform services and/or components. For example, UI 130 may communicate with data services 130 in order to retrieve information related to a submitted request. Further, the UI 130 can be integrated with a generative AI model that functions as both a platform assistant and data gathering component integrated with data acquisition engine 300.

According to the embodiment, platform 100 may comprise a data analytics engine 140 configured to perform various analysis on data obtained by platform 100. In some implementations, the data analysis leverages one or more machine and/or deep learning models to make predictions related to loan origination and/or servicing. According to some embodiments, data analytics engine 140 implements a risk bias model to make predictions about potential risk bias in loans offered by lenders to borrowers. Yet in other embodiments, data analytics engine 140 may leverage a generative AI model trained on multi-modality data such as, for example, data stored in database(s) 200 including natural language text, code (i.e., programming language text), and/or images (e.g., images of documents associated with loan origination), to respond to user queries and provide generated output based on the user query, input data, and the large corpus of multi-modality data used to train the model.

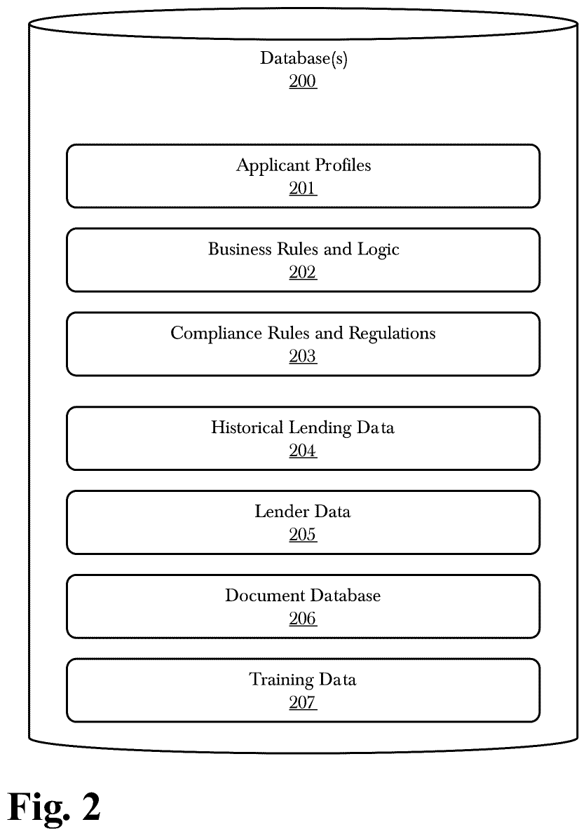

FIG. 2 is a block diagram illustrating an exemplary data 201-207 that may be stored in one or more databases 200, according to an embodiment. According to the embodiment, database(s) 200 may comprise a plurality of information including, but not limited to, a plurality of borrower profiles 201, various business rules and logic 202, compliance rule and regulations 203, historical lending data 204, lender specific data 205, document data 206, and training data 207. Database(s) 200 may also store obtained platform user behavior and interactions such as, for example, clicks, time spent in the system, type of browser used to access the platform, approximate geo-location data, etc. User behavior and interaction data can be used to evaluate platform performance and use. Database(s) 200 may comprise a relational database or a non-relational database or both. Database(s) 200 may comprise one or more non-volatile data storage devices such as, for example, hard drives or thumb drives. The one or more data storage devices may be disposed at a single location. The one or more data storage devices may be distributed over multiple different geographic locations. A single data storage device may comprise various types of databases (e.g., relational, NoSQL, etc.) wherein each type of database may be implemented on a single data storage device. All data stored in database(s) 200 may comply with all local data storage laws and regulation. Information stored in database(s) 200 may or may not be encrypted, dependent upon the embodiment, and further dependent upon the type of data. For example, publicly available data such as lender addresses and phone numbers need not be stored as an encrypted value in database(s) 200, whereas personal identifying information (PII) or PHI will always be encrypted when being stored and during data processing and analysis operations. In some implementations, database(s) 200 can be separated in unique, segregated repositories or hybrid containers to meet client security requirements or other needs.

According to the embodiment, database 200 comprises one or more borrower profiles 201. Each borrower profile is associated with a specific borrower and configured to store all obtained documents and information associated with the specific borrower. A borrower may be prompted to create a profile during the borrower's initial interaction with platform 100 via UI 130. In some implementations, the generative AI may assist or otherwise guide the borrower during the creation of his or her profile such as, for example, by requesting of the borrower the necessary information and walking the borrower through each step. Borrower profile data 201 may comprise information that is obtained via borrower/lender submission, sourced directly from third-party services 125 (e.g., from the IRS, etc.), and from the lender 115 via API manager 110. Borrower data may include, but is not limited to, personal information (e.g., name, social security number, date of birth, and contact information), employment and income information (e.g., current and previous employers, length of employment, and income documentation such as pay stubs, W-2s, and tax returns), assets and liabilities (e.g., bank statements, investment account statements, and information about any outstanding depts, etc.), credit history, (e.g., credit score, credit reports, and information about any bankruptcies, foreclosures, or other credit issues), and property information, and/or the like. Borrower profiles may comprise user-defined rules that govern how their data is shared and how data security is implemented. This information may be uploaded by the borrower via UI 130. For example, a borrower can scan her pay stubs or take photos of them on her smart phone and upload the photos or scanned images via UI 130 directly to platform 100. In some implementations, the documents may be uploaded as various file types including, but not limited to, .docx, .doc, .CSV, .pdf, .jpeg, .txt, etc., and need not be in a specific file type. In some implementations, platform 100 may perform a file type conversion as part of the data acquisition process in order to convert obtained data into a standard file type for system processing and analysis.

The borrower profile 201 may act as a repository for validated borrower data and acts as a system of record for the borrower thereby providing utility to the borrower because now they have can have all their required documents and information automatically validated and securely stored until they are ready to shop for home loans. A borrower can get in touch with a lender to begin the loan application process, wherein the lender 115 can initiate the process on their LOS 116, and platform 100 can transmit the borrower's profile data to any lender using the APIs. The data is tied directly to the borrower, so the borrower's data can go directly to a second or more borrower authorized lender without the need for the borrower to submit each and every document and data to each lender individually.

According to the embodiment, database 200 comprises one or more business rules and/or logic 202 which can be used to enforce data compliance with lender systems (e.g., LOS 116) as well as to configure data transformation functions. As each lender may use different LOS platforms, each lender may also have different rules for how data is input or integrated with their platforms. A lender can submit their own rules and logic that can be applied to obtained data during the data acquisition stage or during an API call on the data. For example, a lender has business rules dictate that certain data fields be formatted in upper case lettering and so, platform 100 may format the data according to the rule prior to transmitting the data via API to the lender's LOS such that when the data is easily able to integrate with the lender's LOS.

According to the embodiment, database 200 comprises one or more compliance rules and regulations 203 which may be used to verify and enforce compliance with governmental laws and regulations regarding the storage, transmission, and processing of borrower data. Compliance rules and regulations may be associated with CPPA, GDPR, or other local or governing regulations and comply with standards outlined therein when applicable.

According to the embodiment, database 200 comprises historical lending data 204. The historical lending data may comprise information from lender institutions, governmental agencies, and from borrowers. Lender institutions such as banks and mortgage lenders can provide historical lender data such as, for example, loan duration, number of loans given out, number of loans applied for, number of loans denied, reasons for loan denial, interest rates, terms, fees, down payments, closing costs, and/or the like. Borrowers can also provide this information, for example, when a borrower applies receives a loan from a lender they can upload the loan terms and data which can be saved to their profile 201 and as historical lending data 204. This information can be provided by lenders via APIs. Historical lender data can also be sourced from third-party sources 125 and publicly available databases. For example, information reported under the Home Mortgage Disclosure Act (HMDA) from over 4,300 U.S. financial institutions may be obtained by platform 100 via data acquisition engine 300 and leveraged by one or more machine learning algorithms to assess potential fair lending risks and for other purposes. HMDA data is useful as an input into platform 100 because it includes a total of 48 data points providing information about borrowers, the property securing the loan or proposed to secure the loan in the case of non-originated applications, the transaction, and identifiers. A complete list of HMDA data points and the associated data fields can be found on the website affiliated with the FFEIC. HMDA data, lender data, borrower data, and risk factors can be used as input into a trained model to evaluate an institution's fair lending risk and other lending biases that may be present and discernable by leveraging big data analysis.

According to the embodiment, database 200 comprises a plurality of lender data 205 for a plurality of various lenders. Lender data 205 may comprise data specific to a particular lender such as, for example, an address, routing information, operating hours, affiliated web address, employee information, etc. Additionally, lender data 205 may comprise lender institution metrics including, but not limited to, earning asset yield, cost of funds, net interest margin, average earning assets, average interest bearing liabilities, non-interest income/total revenue, non-performing loans, coverage of non-performing loans, and/or the like. In some implementations, lender data 205 may be used as an input into one or more machine learning algorithms configured to make predictions associated with a loan application or associated process. In some implementations, a lender may create a lender profile, similar in function to borrower profile 201, which can store the available lender data 205.

According to the embodiment, database 200 comprises a plurality of information on various types of documents related to a loan application forming a document database 206. Exemplary documents can include but are not limited to: tax return documentation; pay stubs, W-2s, or other proof income documentation; bank statement and other assets; credit history documentation; gift letters; photo identification; and renting history documentation. Documents related to tax returns (e.g., Form 4506-T) are often needed for the loan origination process to proceed and can oftentimes be directly acquired by platform directly from the IRS when applicable. Generally, two years of tax return information is necessary for loan application purposes. While tax returns may provide an overall idea of a borrower's overall financial health, pay stubs provide current earnings. Documents can further include 1099 forms and other tax documentation. Asset documentation can include investment assets as well as insurance, such as life insurance which may all come with their own form of documentation. In some implementations, when document is uploaded it may be scanned and classified in order to create an indexable repository of documents from various institutions. The document database 206 may relate scanned and classified documents with a particular institution thereby creating a logical link between identifiable documentation and the institution it originated from. A document library can be leveraged to train a classifier network to identify input documents using labeled datasets of documents, their institution of origination, and key words or features associated with a particular document. For example, most W-2 forms are easily identifiable and have common data fields (e.g., “employee name, address, and ZIP code, “wages, tips, and other compensation”, etc.) which are generally present in various formats of the W-2, whereas pay stub documentation can vary greatly in design and layout, but may contain similar identifiable data fields (e.g., “employee name”, “pay period”, “income”, “rate”, “hours”, “deductions”, “net pay”, etc.). The classifier network may be configured to compare relative documents to each other the learn from experience and then auto-approve documents based on the comparison. For example, the classifier may identify extracted data fields or tags generally associated with pay stubs and can classify the document as a pay stub based on confidence score which indicates the classifier's confidence value that a given document is accurately identified as a particular document such as, for example, a pay stub.

According to the embodiment, database 200 further comprises a plurality of training data 207. The data stored in database 200 may be drawn from to create training and test datasets for training and testing one or more machine and/or deep learning algorithms. These curated training and/or test datasets 207 may be stored in database 200 as a form of data provenance in case there is a need to perform a data audit and for model training and refinement tasks over time. AI engine 400 may retrieve a plurality of data from database(s) 200 and create training datasets as necessary for the training of various machine and/or deep learning algorithms such as, for example, classifier networks, data validation algorithms, and/or a generational AI system.

It should be appreciated that the information 201-207 illustrated herein is only exemplary and does not represent the full extent nor does it limit in any way the types of data and/or the sources from which said data may be obtained. In some implementations, the information obtained by platform 100 and stored in database(s) 200 can include, but is not limited to, borrower and business surveys, online tracking, transactional data tracking, online marketing analytics, social media monitoring data, collecting subscription and registration data, borrower mobile device data and metadata, etc.

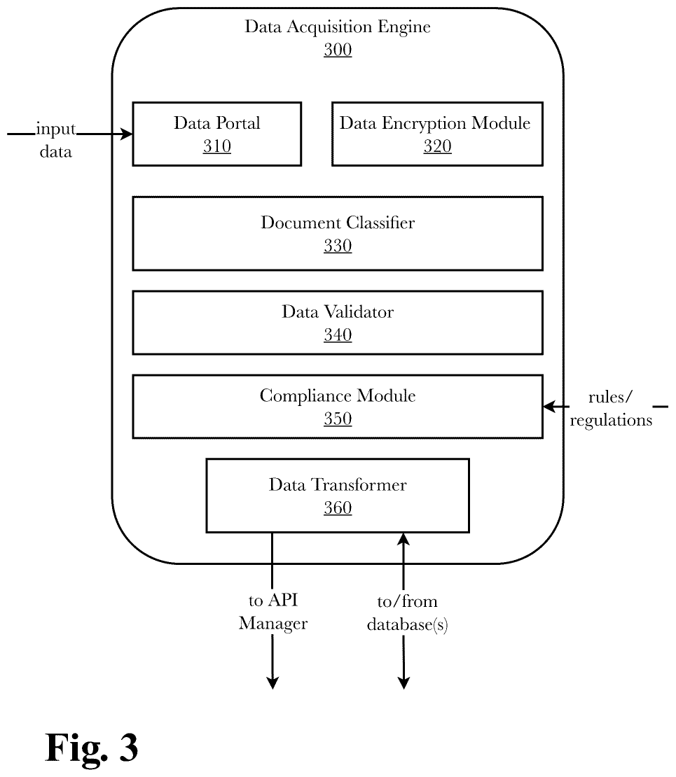

FIG. 3 is a block diagram illustrating an exemplary aspect of a platform for loan origination data validation and predictive analysis, a data acquisition engine 300. According to the embodiment, data acquisition engine (DAE) 300 may comprise a data portal 310 which acts as a gateway to receive a plurality of data from various sources such as, for example, user input received via UI 130, data received via API by way of API manager 110, and data directly received from third-party services 125. In some implementations, data portal 310 may be configured to perform an initial security check on the received data before the data is further processed by DAE 300. For example, the file size of received data may be checked and compared to historical file size values for similar data. Continuing the example, if a borrower is uploading a standard word processing document with text and normal formatting, then data portal 310 would expect a file size to be in the range of 10-500 kB, and if a file size of 1 MB or more is detected, then the current data would be flagged, and an alert can be generated and communicated to the user via UI 130. Data portal 310 may also be configured to check if the received data is encrypted, and if the data is not encrypted then a data encryption module 320 may encrypt the data according to one or more various types of encryption methods known to those with skill in the art. An exemplary encryption algorithm that may be implemented by data encryption module 320 is the advanced encryption standard which is a symmetric block cipher which decrypts data in blocks of 128 bits using cryptographic keys of 128, 192, or 256 bits. Other embodiments may utilize the RSA public-key signature algorithm which uses logarithmic functions (e.g., hash functions) to encrypt the data.

According to the embodiment, data acquisition engine 300 may comprise a document classifier 330 and/or data validator 340 which may each leverage one or more machine and/or deep learning algorithms to perform document classification tasks and data validation tasks on received data. Document classifier 330 may utilize a trained classifier network configured to classify input data as one of a plurality of “known” or “learned” documents. In a use case, document classifier 330 receives one or more documents uploaded to platform 100 by a borrower (or a lender) who is preparing to shop for home loans, and classifies the uploaded documents based on identified key words and/or identified data features. For example, an uploaded document may be scanned (e.g., optical character recognition, etc.) and the data fields extracted and analyzed by a classifier network configured to output a predicted document type based on the analysis of the extracted data fields. The output of the classifier network can be used to identify the uploaded document. The identity of the document can be used by data validator 340 which can check each of the extracted data fields to check the validity of the data and assigning a confidence score to each data field, wherein the confidence score indicates a confidence that a given data fields contains valid data. In some embodiments, a trained regression model may be utilized which receives input data fields and an indication of the type of document the data fields are associated with, and outputs a confidence score indicating whether the data is valid, or should be flagged for review by a human (e.g., lender). Flagged data may be communicated back to the system user via UI 130 or sent to a lender 115 via API manager 110.

In various implementations, any of DAE 300 components 330-350 may utilize, in conjunction with machine learning, computer vision, OCR, natural language processing, and other techniques.

According to the embodiment, data acquisition engine 300 may also comprise a compliance module 350 configured to enforce compliance with any business rules and logic as well as any governmental rules and regulations which may apply to the data being processed. Compliance module 350 may retrieve a plurality of rules, regulations, and logic from database(s) 200 and apply these to the data. A data transformer 360 may be used to transform the data to comply with any rules or regulations. For example, a business rule may indicate that a certain data field must have a specific number of significant figures and data transformer 360 can transform the data so that it contains the correct amount of significant figures. Data transformer 360 may keep a record of each transform made to each data and store the record in database 200 so that a record can be kept for data provenance and data auditing use cases. Data transformer 360 may also transform data as necessary prior to storage if the type of database requires a certain data format. Furthermore, data transformer 360 can apply business rules and logic to transform data retrieved from storage prior to sending the data to API manager 110, the transformed data is then ready to integrate easily with the business systems such as, for example, a LOS 116 of a lender 115. In the event of a business rule failure or the occurrence of invalid data, a lender may be able to manually intervene in the process by reviewing the failed rule or invalid data, allowing the lender (or borrower) to correct the data via the website/web app UI, and then updating the LOS or intended recipient platform as necessary. Data acquisition engine 300 can identify, sort, and clean document placeholders. For example, documentation may be placed in a LOS 116 folder system and is then automatically reviewed by platform 100, a correct placeholder is determined, and then it is moved to the appropriate placeholder. In this process the document may be transformed wherein excess and misaligned documentation is removed.

A use case for platform 100 and data acquisition engine 300 may be directed to updating purchase advice information without entering a loan. In this use case, purchase advice data can be uploaded to platform 100 and data is extracted from it. A confidence score may be given to all identified data points, wherein the confidence score indicates an acceptable accuracy score. Data will be cross referenced and standardized with a LOS 116 of record. Once all data has been thoroughly vetted and approved, updates can be loaded into the LOS or accounting platform of the borrower's choice without the need of re-validation.

A use case for platform 100 and data acquisition engine 300 may be directed to borrower identification verification. In this use case, platform 100 verifies that the identification documents are correct and match other data in the LOS 116. If discrepancies are found, platform 100 can alert the user and display the identified issues via UI 130. Once an ID passes all checks, it is placed in the LOS identification placeholder along with a completed customer identification procedure (CIP) form (also referred to as a Patriot Act form). If the ID is incorrect or expired, platform 100 can alert the user and move that document to a miscellaneous placeholder.

Another use case for platform 100 may be directed to homeowner's insurance validation. In this use case, platform 100 validates a homeowner's insurance document is correct and does not have invalid, outdated data. Validation data can include, borrower name, address, start date, policy term, yearly premium, loss payee, replacement cost coverage, and deductible. If there are any discrepancies, platform 100 can alert the user and display the identified issues. If all information is verified correct, then the data can be automatically placed into LOS 116 homeowner's insurance forms. Yet another use case for platform 100 may be directed to income calculation and validation. In this use case, platform 100 directly obtains personal and business tax transcripts along with W-2's for borrowers from the IRS. The borrower's identification is confirmed (e.g., using a digital service such as ID.me). Selected documents may then be sent to the borrower's selected lender's LOS 116 with the income automatically calculated.

Another use case for platform 100 may be directed to automated, personalized generated mortgage loan estimates based at least on user input data and leveraging a generative AI model. In such a use case, a borrower can upload the documents and information he or she has available, and query the generative AI model for a mortgage estimate from one or more potential lenders.

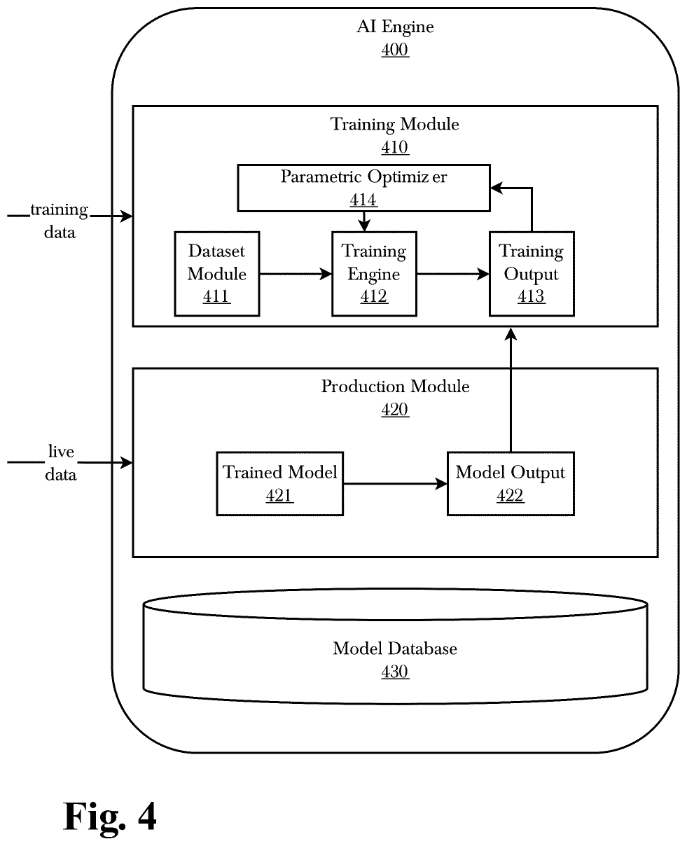

FIG. 4 is a block diagram illustrating an exemplary aspect of a platform for loan origination data validation and predictive analysis, an artificial intelligence engine 400. AI engine 400 is configured to manage the creation, maintenance, and application of one or more machine and/or deep learning models. According to the embodiment, AI engine 400 comprises a training module 410 wherein new models may be trained using various machine and/or deep learning algorithms. A dataset module 411 is configured to receive, retrieve, or otherwise obtain a plurality of data from various sources, pre-process the data to prepare it to be used as input into a training engine 412. Pre-processing data may involve, but is not limited to, formatting the dataset (e.g., CSV, HTML, XLSX, etc.), extract variables (e.g., independent and dependent variables), identifying and handling missing values (e.g., deletion, calculating the mean, etc.), encoding categorical data, splitting the dataset (e.g., split into a training set and test set), feature selection and scaling, data cleaning, data transformation (e.g., normalization, attribute selection, discretization, concept hierarchy generation, etc.), data reduction (e.g., data cube aggregation, attribute subset selection, numerosity reduction, dimensionality reduction, etc.), and/or the like. Dataset module 411 can use data obtained from database 200 and external resources such as third-party services 125. Data from these, and other sources, may be used as training data and dataset module 411 can split this dataset into a training dataset and a test dataset. The training dataset may comprise, for example, 80-90% of the total dataset and the test dataset would comprise the remaining 10-20% of the total dataset. The training dataset may be fed into training engine 412 which uses the training dataset as input into a machine or deep learning algorithm in order to train a model that can be used by platform 100 components to assist borrowers with managing and validating their data. Training engine 412 can allow data scientist and software engineers to train and create models using machine learning techniques by providing them an interface with which to set model parameters such as, for example, error rate, learning rate, weight decay, mini-batch-size, dataset size, epochs, and/or the like.

Training output 413 is produced and can be used as feedback to check the progress of a model in training and make changes to model parameters and hyperparameters via parametric optimizer 414. Parametric optimizer 414 can be configured to apply model tuning via parameter adjustment between model training stages. This represents the iterative training process common when training machine and/or deep learning models, wherein a model is trained using training data, tested using test data, model output analyzed, and model tuning applied until some goal is achieved, usually related to model error rate. Examples of parameters and hyperparameters that may be modified via parametric optimizer 414 can include, but are not limited to, train-test split ratio, learning rate in optimization algorithms, choice of optimization algorithm (e.g., gradient descent, stochastic gradient descent, of Adam optimizer), choice of activation function in a neural network layer (e.g., Sigmoid, ReLU, Tanh, etc.), choice of cost or loss function the model will use, number of hidden layers in a neural network, number of activation units in each layer, the drop-out rate in neural networks, number of epochs, number of clusters in a clustering task, Kernel or filter size in convolutional layers, pooling size, batch, size, the coefficients (or weights) of linear and logistic regression models, weights and biases of a neural network, the cluster centroids in clustering, etc.

A fully trained and tested model is ready to go into production to analyze live data and make predictions. Production module 420 receives a trained model 421 and uses the trained model to make predictions 422 on live data instead of training data. The model output 422 may be used to assist platform components perform various tasks such as classification, validation, and user guidance. For example, a trained model may be a trained classifier network configured to classify input data as one or a plurality of documents associated with the origination of a loan such as a home loan or auto loan. Another example model which may be implemented by platform 100 is a data validation model using a trained regression algorithm to generate a confidence score indicating whether the processed data is valid or not. Yet another model which may be implemented by platform 100 is a generative AI model which can assist platform users (e.g., borrowers and lenders alike) with system onboarding, data collection, query response, recommendations, and/or the like. Another model that may be implemented by platform 100 may be configured to identify potential fair lending risks and/or other biases in the lending process that may adversely affect a borrower.

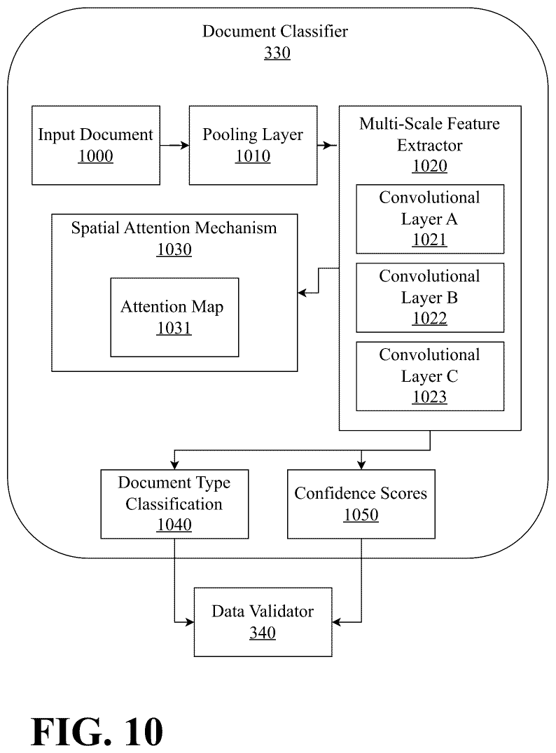

A model database 430 is present and configured to store information related to the one or more machine and/or deep learning models that may be implemented by trained and managed by AI engine 400. Model database 430 may store current and previous version of production models as well as the training and test datasets associated with each model. Model database 430 may also comprise a record of the transformations applied during data pre-processing to a training dataset. FIG. 10 is a block diagram illustrating an exemplary architecture of a document classifier implementing CNN-based classification with spatial attention mechanisms, according to an embodiment. According to an embodiment, document classifier 330 receives an input document 1000 which may have varying dimensions depending on its source. This variability in document dimensions presents a technical challenge for traditional document processing systems that expect standardized inputs.

Input document 1000 is first processed by a pooling layer 1010, which implements adaptive pooling to normalize documents of varying dimensions to a fixed size suitable for CNN processing. Pooling layer 1010 may employ adaptive average pooling or adaptive max pooling techniques that automatically adjust the pooling kernel size and stride based on the input dimensions to produce a consistent output size. This normalization preserves the spatial relationships and content integrity of the original document while standardizing the dimensions for downstream processing. Unlike simple resizing which can distort text and degrade readability, pooling layer 1010 maintains the aspect ratio and ensures financial data fields remain legible and properly positioned relative to each other.

The normalized output from pooling layer 1010 is fed into a multi-scale feature extractor 1020 comprising a plurality of convolutional layers 1021-1023. Multi-scale feature extractor 1020 is designed to capture document features at different levels of abstraction. Convolutional layer A 1021 operates with smaller kernel sizes (e.g., 3×3) to detect low-level features such as edges, corners, and individual characters. Convolutional layer B 1022 uses medium-sized kernels (e.g., 5×5) to identify mid-level features including text blocks, form fields, table structures, and boxes commonly found in financial documents. Convolutional layer C 1023 employs larger kernels (e.g., 7×7 or 9×9) to capture high-level semantic features representing entire document sections, headers, and the overall document layout. Each convolutional layer 1021-1023 may include batch normalization and Rectified Linear Unit (ReLU) activation functions to improve training stability and feature extraction capability. Three convolutional layers as depicted in FIG. 10 is exemplary and multi-scale feature extractor 1020 may have any plurality of convolutional layers depending on the desired granularity.

The feature maps generated by multi-scale feature extractor 1020 are processed by a spatial attention mechanism 1030 that learns to focus on document regions most likely to contain financial data fields. Spatial attention mechanism 1030 implements a learned attention function that takes the concatenated feature maps from convolutional layers 1021-1023 as input and produces an attention map 1031. Attention map 1031 assigns weight values between 0 and 1 to each spatial location in the feature maps, with higher weights indicating regions of greater importance for document classification. For example, in a W-2 form, attention map 1031 might assign high weights to regions containing boxes 1 (wages), 2 (federal tax withheld), and 3 (social security wages), while assigning lower weights to decorative elements or blank spaces.

Spatial attention mechanism 1030 may be implemented using various architectures such as squeeze-and-excitation networks, self-attention modules, or convolutional attention networks. The attention weights are learned during training by backpropagating classification errors, causing the network to automatically discover which document regions are most discriminative for each document type. This attention-based approach provides several technical advantages: it reduces computational requirements by focusing processing on relevant regions, improves classification accuracy by filtering out noise and irrelevant information, and provides interpretability by visualizing which document areas influenced the classification decision.

The attention-weighted features are then processed to generate a document type classification 1040 and associated confidence scores 1050. Document type classification 1040 represents the predicted document category (e.g., “W-2”, “1099-INT”, “Pay Stub”, “Bank Statement”, etc.) determined by applying a softmax function to the final layer outputs. Confidence scores 1050 provide probability values for each possible document class, allowing the system to quantify its certainty in the classification. For instance, a document might be classified as “W-2” with confidence score 0.95, “1099-MISC” with score 0.03, and “Pay Stub” with score 0.02, indicating high confidence in the W-2 classification.

Both document type classification 1040 and confidence scores 1050 are passed to data validator 340 for subsequent validation processing. This integration ensures that data validator 340 can apply the appropriate parsing patterns and validation rules based on the identified document type, improving the accuracy and efficiency of the overall loan origination data validation process. The confidence scores also enable data validator 340 to flag low-confidence classifications for manual review, maintaining system reliability even for unusual or degraded documents.

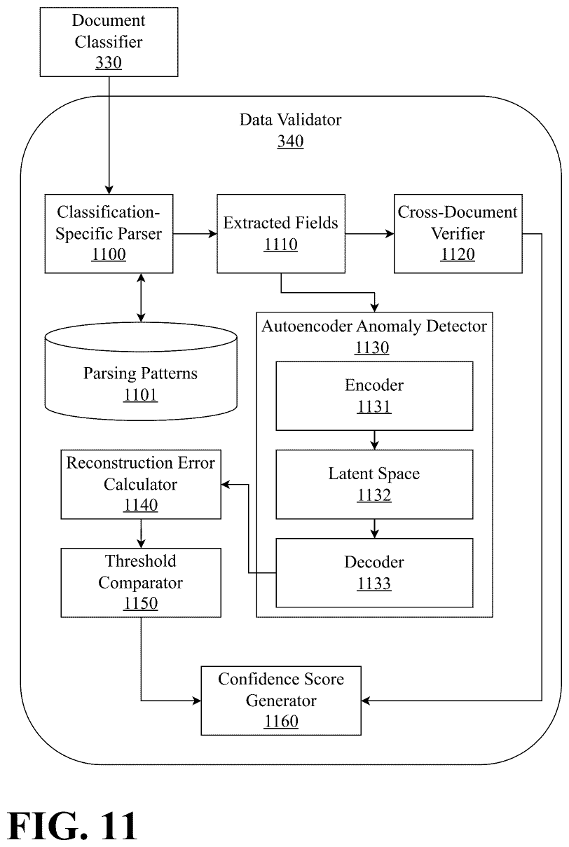

FIG. 11 is a block diagram illustrating an exemplary architecture of a data validator implementing advanced validation techniques including autoencoder-based anomaly detection and cross-document verification, according to an embodiment. Data validator 340 receives input from document classifier 330, including document type classification 1040 and confidence scores 1050 as described in FIG. 10.

A classification-specific parser 1100 serves as the initial processing component within data validator 340. Classification-specific parser 1100 retrieves appropriate parsing patterns from a parsing patterns database 1101 based on the document type received from document classifier 330. Parsing patterns 1101 comprises a comprehensive repository of document-specific extraction rules, regular expressions, and positional templates for various financial document types. For example, when processing a W-2 form, classification-specific parser 1100 retrieves W-2-specific patterns that define the exact locations and formats of boxes 1-20, including patterns for extracting employee SSN from box a, employer EIN from box b, wages from box 1, and federal income tax withheld from box 2. For bank statements, parsing patterns 1101 provides templates for identifying transaction tables, running balances, and account summary sections.

Classification-specific parser 1100 applies the retrieved patterns to extract data fields from the document, producing extracted fields 1110. Extracted fields 1110 represents a structured collection of key-value pairs containing the financial data parsed from the document. For instance, from a W-2 form, extracted fields 1110 might include {“employee_name”: “John Doc”, “ssn”: “XXX-XX-1234”, “wages”: “52000.00”, “federal_tax_withheld”: “8500.00”, “social_security_wages”: “52000.00”, “medicare_wages”: “52000.00”} and additional fields. The extraction process handles various data formats, including currency values with or without dollar signs, SSNs with or without dashes, and dates in multiple formats.

Extracted fields 1110 are simultaneously processed by two validation pathways: an autoencoder anomaly detector 1130 and a cross-document verifier 1120. This parallel processing architecture enables comprehensive validation that combines statistical anomaly detection with logical consistency checking.

Autoencoder anomaly detector 1130 implements a deep learning approach to identify potentially erroneous or fraudulent values in extracted fields 1110. The autoencoder comprises an encoder 1131, a latent space 1132, and a decoder 1133. Encoder 1131 progressively compresses the input field values through multiple neural network layers, reducing dimensionality from the original feature space (e.g., 20-50 financial fields) down to a compact latent space 1132 representation (e.g., 8-16 dimensions). This compression forces the network to learn the most salient patterns and relationships among normal financial data values.

Latent space 1132 represents the compressed encoding of the financial data, capturing the essential characteristics of typical loan application documents. During training on historical loan data, autoencoder anomaly detector 1130 learns to encode and reconstruct normal value ranges and relationships. For example, it learns typical relationships between income and tax withholding, expected ranges for different income brackets, and common patterns in financial data.

Decoder 1133 attempts to reconstruct the original field values from latent space 1132 representation. The reconstruction process reverses the encoding, expanding from the compressed representation back to the original dimensionality. Under normal conditions with typical financial values, decoder 1133 can accurately reconstruct the input with minimal error. However, anomalous values that deviate from learned patterns result in higher reconstruction errors.

A reconstruction error calculator 1140 computes the difference between the original extracted fields 1110 and the reconstructed values from decoder 1133. Reconstruction error calculator 1140 may employ various error metrics such as mean squared error (MSE), mean absolute error (MAE), or a custom weighted error function that assigns different importance to different fields. For instance, errors in fields like SSN or income might be weighted more heavily than errors in optional fields.

A threshold comparator 1150 evaluates whether the reconstruction error exceeds learned thresholds for each field type. These thresholds are established during training by analyzing the reconstruction error distribution for known good data and setting thresholds at appropriate percentiles (e.g., 95th or 99th percentile). Fields with reconstruction errors exceeding their thresholds are flagged as potential anomalies requiring further review.

Meanwhile, cross-document verifier 1120 performs logical consistency checking across multiple documents in the borrower's profile. Cross-document verifier 1120 implements relationship rules that ensure consistency between related fields across different document types. For example, it may verify that: annual income reported on tax returns aligns with the sum of pay stubs for the year; employer information is consistent across W-2s, pay stubs, and employment verification letters; bank statement deposits correspond to reported income sources; and address information matches across all documents. Cross-document verifier 1120 builds a graph structure representing relationships between fields across documents, enabling multi-document validation that would be impossible with single-document analysis.

A confidence score generator 1160 aggregates results from threshold comparator 1150 and cross-document verifier 1120 to produce field-level validation confidence scores. Confidence score generator 1160 implements a scoring algorithm that may consider multiple factors such as but not limited to the magnitude of reconstruction error relative to the threshold, the number and severity of cross-document inconsistencies, the confidence scores from the original document classification, and the historical reliability of the specific field type. The output is a detailed confidence score for each field, typically ranging from 0.0 (no confidence) to 1.0 (full confidence).

The architecture of data validator 340 provides several technical advantages over traditional rule-based validation systems. The autoencoder-based approach can detect subtle anomalies that would evade rule-based systems, such as values that are individually plausible but unusual given the overall financial profile. The cross-document verification ensures data consistency across the entire loan application package. The confidence scoring system provides granular feedback that enables intelligent handling of validation results, from automatic acceptance of high-confidence data to targeted manual review of specific problematic fields.

### Detailed Description of Exemplary Aspects

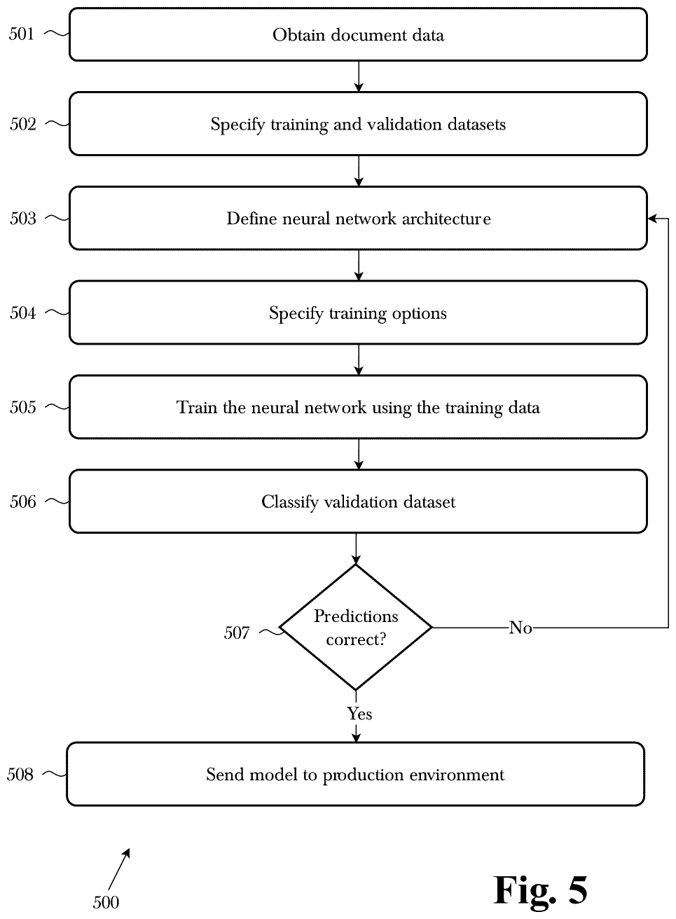

FIG. 5 is a flow diagram illustrating an exemplary method 500 for training a document classifier network, according to an embodiment. According to the embodiment, the process may be conducted by AI engine 400 and begins at step 501 wherein a plurality of document data is obtained. Document data may be obtained from database 200. Document data may be gathered directly from lenders 115 or from data uploaded by borrowers 105. Document data may be labeled data wherein specific documents are given a label that states what type of document it is. For example, pay stub documentation may be labeled “pay stub” and a W-2 may be labeled “W-2”. In some implementations, lenders 115 may upload proprietary documents with appropriate labels and this may be included in the document data. The document data may comprise a large corpus of labeled document data which can be split into a training dataset and a validation (e.g., test) dataset at step 502.

Once the data has been pre-processed and split into training and validation datasets, the next step 503 involves defining the neural network that will be the architecture for the document classifier. For example, if document classifier is based on convolutional neural network (CNNs) architecture, then some exemplary network definitions can include document input layer, convolutional layer, batch normalization layer, ReLU layer, max pooling layer, fully connected layer, softmax layer, and the classification layer. Document input layer is where the document size is specified and is related to the channel size of the network. Convolutional layer defines the filter size, number of filters, and use of padding, if applicable, and can be used to define the stride and learning rates for this layer. Batch normalization layer normalize the activations and gradients propagating through a neural network, making neural network training an easier optimization problem. The use of batch normalization layers between convolutional layers and nonlinearities, such as ReLU layers, can speed up neural network training and reduce the sensitivity to neural network initialization. The ReLU (rectified linear unit) layer is a nonlinear activation function. The fully connected layer comes after the convolutional or down-sampling layers and this layer combines all the features of the previous layers across the document to identify larger patterns. Softmax layer is an activation function that normalizes output of the fully connected layer. The output of the Softmax layer consists of positive numbers that sum to one, which can then be used as classification probabilities by the classification layer.

Once a neural network has been defined, the next step 504 is to select the training options. Training options can include, but are not limited to, number of epochs, initial learning rate, validation data, validation frequency, etc. In some implementations, the document classifier may be trained using stochastic gradient descent with momentum (SGDM) with a low initial learning rate (e.g., 0.01). An epoch is full training cycle on the entire training dataset. During training, the model can be monitored for accuracy by specifying the validation data and validation frequency. In some implementations, the data is shuffled every epoch. At step 505 AI engine 400 trains the neural network using the architecture defined by the above layers, on the training data, and the training options. At step 506 AI engine 400 calculates the accuracy on the validation data at regular intervals during model training. At step 507, if the validation data is producing accurate output, that is, the classifier is correctly classifying validation data, then the document classifier network is ready to be used in a production environment and can be sent to production module 420 at step 508. If instead, the validation dataset does not produce accurate results, then the process may loop back around to step 503, wherein model adjustments can be made to either the training and validation datasets, the defined layers, and/or the training options.

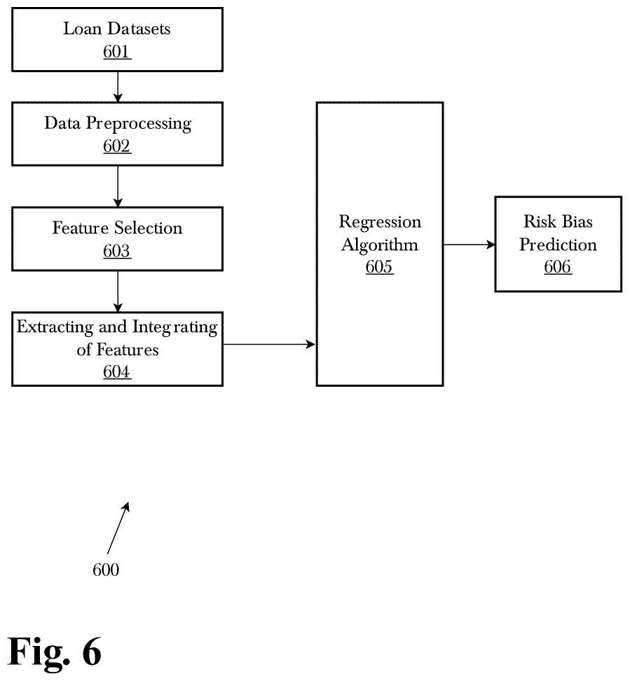

FIG. 6 is a flow diagram illustrating an exemplary method 600 for training a machine learning regression algorithm to make predictions related to risk bias, according to an embodiment. According to the embodiment, the process may be conducted by AI engine 400 and begins at step 601 when platform 100 obtains a loan dataset. According to the embodiment, loan dataset may comprise some, none, or all of the data stored in database 200 as well as data obtained from lenders 115 and third-party services 125. Loan datasets may comprise a plurality of information about a plurality of borrower's and about a plurality of lenders. Borrower data can comprise any information stored in the borrower profile 201 of database 200 such as borrower financial data, demographic data, location data, etc. Loan dataset may comprise historical lending data 204 associated with a lender 115 as well as lender data 205. At step 602 the loan dataset may be preprocessed for input into a machine learning regression algorithm. At a next step 603 feature selection is conducted on the pre-processed loan dataset. Feature selection is the process of identifying and selecting a subset of input variables that are most relevant to the target variable. In some embodiments, feature selection may be performed using techniques known to those skilled in the art such as, for example, correlation statistics or mutual information statistics. Correlation is the measure of how two variables (i.e., features) change together and can be determined using a Gaussian distribution and a linear relationship between variables, according to some implementations. Mutual information feature selection is from the field of information theory and applies information gain to feature selection. Mutual information is calculated between two variables and measures the reduction in uncertainty for one variable given a known value of the other variable. Mutual information is straightforward when considering the distribution of two discrete (categorical or ordinal) variables, such as categorical input and categorical output data (e.g., tax transcript data such as “marital status” and “married” and other categorical input/output pairs).

Next, is step 604 which involves extracting and integrating the selected features. In some implementations, an autoencoder may be utilized to perform feature extraction. An autoencoder is a type of neural network that can be used to learn a compressed representation of raw data. An autoencoder is composed of encoder and decoder sub-models. The encoder compresses the input, and the decoder attempts to recreate the input from the compressed version provided by the encoder. After training, the encoder model is saved, and the decoder is discarded. The encoder can then be used as a data preparation technique to perform feature extraction on raw data that can be used to train a different machine learning model. According to some embodiments, the autoencoder may make use of a self-supervised learning method.

At step 605 the pre-processed data and extracted features may be fed as input into a regression algorithm in order to train a model which can predict risk bias associated with a borrower and a lender, a location, or some other criteria. The type of regression algorithm selected may be dependent upon the embodiment. Exemplary regression algorithms that may be used can include support vector regression, logistic regression, linear regression, ridge regression, neural network regression, lasso regression, decision tree, random forest, KNN model, and/or the like. The model may be trained in a training loop and repeated as necessary until the model provides accurate predictions on a validation dataset. A fully trained model may be deployed into a production environment and fed live data to make risk bias predictions at step 606. Live data may include: borrower information including contact information, demographic information, and financial information; lender data including historical lending data; and applicable third-party data such as, for example, data from governmental or regulatory agencies. Risk bias predictions may be based on a specific lender such that the specific lender's data and a borrower's data may be input into the regression model and a risk bias score may be calculated for the borrower with respect to the lender. For example, the regression model may predict, based on borrower demographics, property locations, historical lender data, and third-party data, that a given lender may have a risk bias which causes the loan term to be different for African-American borrowers than for Caucasian borrowers. Another example may indicate a risk bias is associated with a specific neighborhood if the borrower is a gay person seeking a home loan for a house for sale in the specific neighborhood. The model may indicate via a risk bias score that there is potentially an occurrence of risk bias for a given transaction. A borrower can use this information to advocate for themselves when receiving loan terms from a lender or to use a pre-screening method to filter potential lenders with whom the borrower may choose to apply for a loan with. Governments and regulatory bodies can use the risk bias information to monitor and measure risk bias in lending which can be used to shape policy and rules to benefit groups or individuals that the bias adversely affected. Lenders can use the risk bias information to improve standard and enforce compliance with fair lending laws and other regulations that govern loan origination.

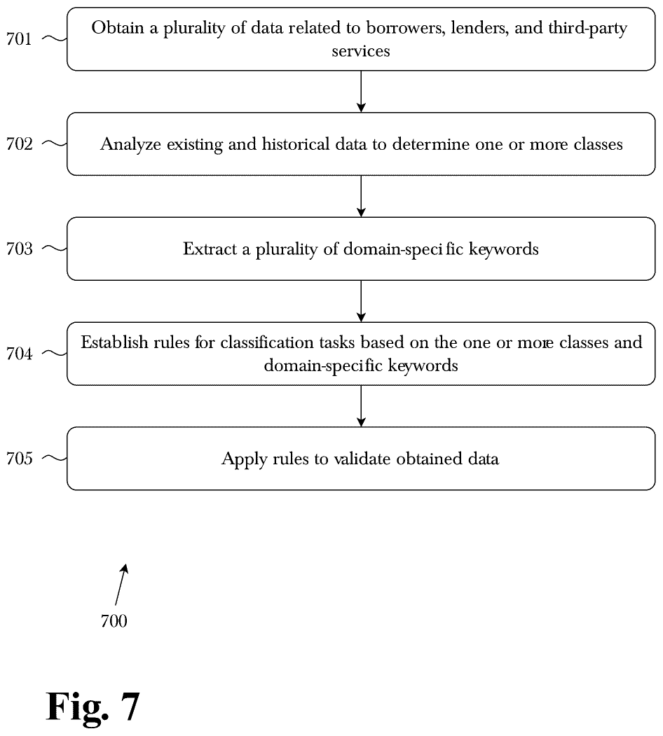

FIG. 7 is a flow diagram illustrating an exemplary process 700 for implementing rules-based text and data validation model, according to an embodiment. According to the embodiment the process begins at step 701 wherein platform obtains a plurality of data related to borrowers, lenders, and third-party services. Examples of obtained data are discussed above, referring to FIG. 2. As a next step 702 the obtained data is analyzed in conjunction with historical data to determine one or more classes associated with text and/or data fields for a given document type. For example, a document type associated with an invoice may have a class data field associated with “invoice” or “payment amount” and/or the like. At the next step 703 a plurality of domain-specific keywords may be extracted from the obtained data. Domain-specific keywords refer to a set of vocabulary of words or phrases used in specialized areas, or domains, that carry specific meaning. For example, AI engine 400 may analyze the obtained data and determine that “credit rating” is a keyword associated with credit report documents based on the amount of times the keyword is encountered during analysis of a plurality of credit report documents. In other implementations, simple if/then code logic may be used to make decisions associated with business rules and logic. At step 704, AI engine 400 may establish rules for classification and data validation tasks based on the one or more classes and domain-specific keywords. As a final step 705, the established rules are applied to extracted data fields in order to validate obtained data.

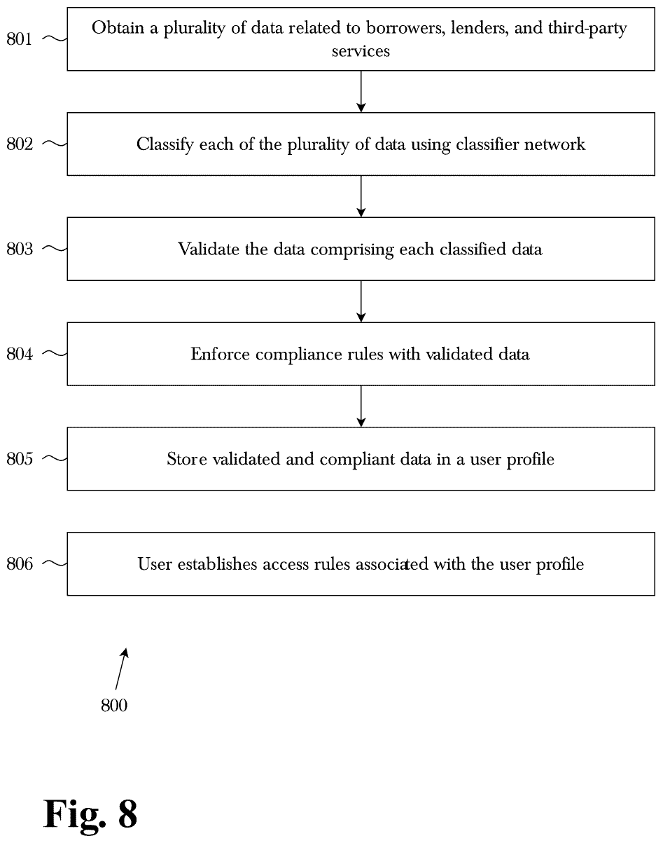

FIG. 8 is a flow diagram illustrating an exemplary method 800 for processing uploaded data into user profiles, according to one aspect. According to the aspect, the process begins at step 801 when data acquisition engine 300 obtains a plurality of data related to borrowers, lenders, and/or third party services. The obtained data may pre-processed and/or encrypted, dependent upon the embodiment, prior to being used as input into a classifier network configured to classify received data as a type of document associated with loan origination at step 802. Once a classification label has been accurately applied to an obtained document, data acquisition engine 300 may perform data validation actions using a trained machine and/or deep learning model at step 803. At step 804 compliance rules and regulations may be retrieved and applied to enforce data compliance on the validated data. At step 805, the validated and compliant data may be stored in a user profile. The user profile may be associated with a borrower, a lender, and/or in some instances, a third-party service. As a last optional step 806, the user (e.g., borrower or lender) can establish access rules associated with the user profile. For example, a borrower can provide data access authorization to certain lenders, wherein the borrower's data can be integrated with those lenders' LOS. For instance, a borrower could set authentication rules for access to the user profile.

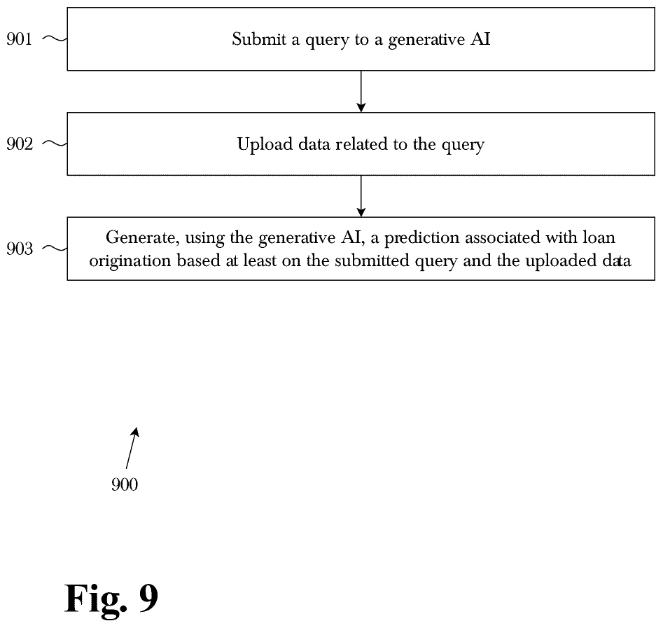

FIG. 9 is a flow diagram illustrating an exemplary method 900 for generating prediction associated with loan origination utilizing generative AI, according to one aspect. A data analytics engine 140 may leverage a trained generative AI model to facilitate user interaction such as receiving various user queries associated with the loan origination process and mortgages in general. The process begins at step 901 when a user submits a query to a generative AI model implemented by platform 100. The user may access the generative AI via UI 130 which may provide, for example, a chat box or similar mechanism which allows the user to type (or in some instances with speech to text capabilities, speak) a query which may be provided to the generative AI as an input. The generative AI may respond by requesting that the user provide documentation or other information related to the query or by requesting the user provide specific documentation and/or information. At step 902 the user can upload the data related to the query via UI 130. At step 903, the generative AI generates a prediction associated with loan origination based at least on the submitted query and the uploaded data in response to the user query.

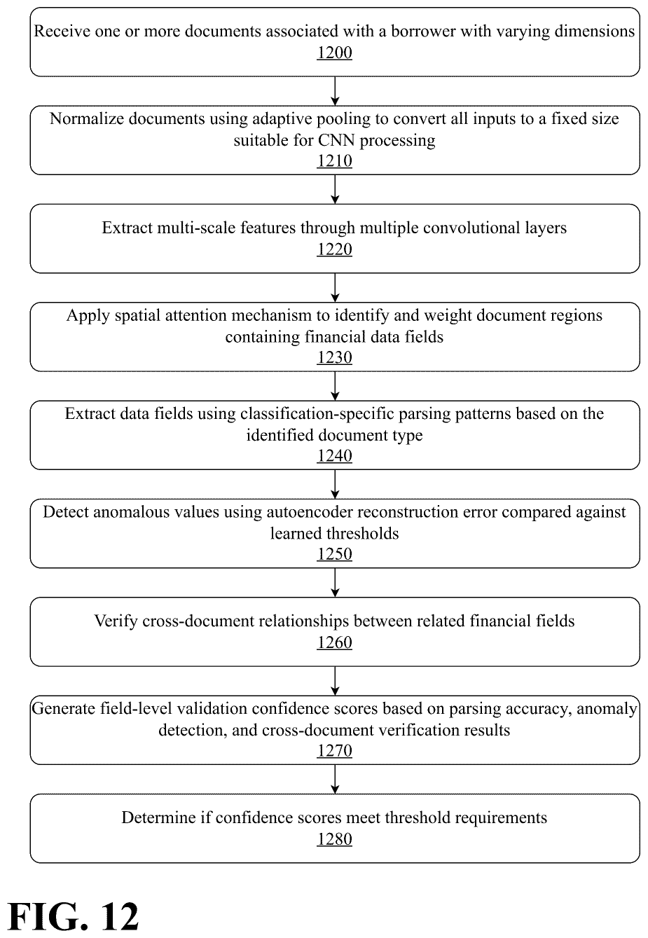

FIG. 12 is a flow diagram illustrating an exemplary method for enhanced document classification and validation using CNN and autoencoder architectures, according to an embodiment. In a first step 1200, receive one or more documents associated with a borrower with varying dimensions. These documents represent the diverse array of financial documentation required for loan origination, including but not limited to W-2 forms, 1099 forms, pay stubs, bank statements, tax returns, and employment verification letters. The documents may originate from various sources and consequently have different dimensions. This dimensional variability presents a significant technical challenge as traditional document processing systems typically require standardized input formats.

In a step 1210, normalize documents using adaptive pooling to convert all inputs to a fixed size suitable for CNN processing. Adaptive pooling algorithms dynamically adjust pooling parameters based on input dimensions. Unlike simple image resizing which can introduce aliasing artifacts and degrade text readability, adaptive pooling preserves the spatial relationships between document elements while standardizing dimensions. The adaptive pooling operation divides the input image into a grid of regions and applies pooling (average or max) within each region, with region sizes automatically calculated based on the input-to-output dimension ratio.

In a step 1220, extract multi-scale features through multiple convolutional layers. Each convolutional layer operates at a different scale to capture hierarchical document features. The first layer might use 3×3 kernels with 64 filters to detect edges and character strokes, learning to identify the basic building blocks of text and form elements. Intermediate layers employ larger kernels (e.g., 5×5 with 128 filters) to recognize text blocks, form fields, and table cells. Deeper layers use even larger receptive fields to understand document layout, identifying headers, sections, and the overall document structure. The multi-scale approach ensures robust feature extraction regardless of document type or quality.

In a step 1230, apply spatial attention mechanism to identify and weight document regions containing financial data fields. The attention mechanism learns to assign importance weights to different spatial locations in the feature maps, effectively creating a heat map of document relevance. For a W-2 form, the mechanism might learn to focus strongly on the numbered boxes containing wage and tax information while down-weighting decorative borders or company logos. The attention weights are computed using a learned function that considers both the local features at each position and the global context of the document. This selective focus improves both accuracy and computational efficiency by concentrating processing resources on the most informative document regions.

In a step 1240, extract data fields using classification-specific parsing patterns based on the identified document type. Based on the document classification from previous steps, the appropriate parsing template is retrieved and applied. For a W-2 classified with high confidence, the parser applies W-2-specific patterns that know to look for Box 1 wages in a specific position, expect Box 2 federal tax withholding below it, and extract the employer identification number from Box b. The parsing patterns accommodate variations in form layouts across different years and issuers while maintaining accuracy. Extracted fields are structured as key-value pairs ready for validation.

In a step 1250, detect anomalous values using autoencoder reconstruction error compared against learned thresholds. The extracted field values are fed through a trained autoencoder which attempts to compress and reconstruct them. Normal values that fit learned patterns reconstruct with low error, while anomalous values produce high reconstruction errors. The reconstruction error is quantified and compared against learned thresholds to determine if values exceed acceptable limits. For example, if a W-2 shows wages of $50,000 but federal tax withholding of $25,000 (50% effective tax rate), the autoencoder would likely produce a high reconstruction error as this relationship deviates significantly from typical patterns in the training data.

In a step 1260, verify cross-document relationships between related financial fields. This step ensures consistency across the borrower's entire document portfolio by constructing a graph of relationships between fields across different documents and checking logical constraints. For instance, it verifies that the sum of wages from all W-2s matches the wages reported on the tax return, that employer information is consistent between pay stubs and W-2s, and that bank deposits align with reported income. This multi-document validation catches inconsistencies that single-document analysis would miss, such as a borrower submitting W-2s from two different employers but pay stubs from only one.

In a step 1270, generate field-level validation confidence scores based on parsing accuracy, anomaly detection, and cross-document verification results. The scoring algorithm weighs multiple factors: the confidence from the initial document classification, the clarity of the extracted text, the reconstruction error magnitude from anomaly detection, and the number of satisfied cross-document constraints. Each field receives a score between 0.0 and 1.0, with scores above a threshold (e.g., 0.8) indicating high confidence in the field's validity.

In a step 1280, determine if confidence scores meet threshold requirements. Fields with confidence scores exceeding the threshold proceed to storage along with their validation metadata. Fields falling below the threshold are flagged for manual review, with specific alerts generated indicating the nature of the validation concern—whether it's a potential anomaly, a cross-document inconsistency, or a parsing uncertainty. This selective approach to manual review significantly reduces the workload on human reviewers while maintaining high accuracy standards for loan origination data.

### Exemplary Computing Environment

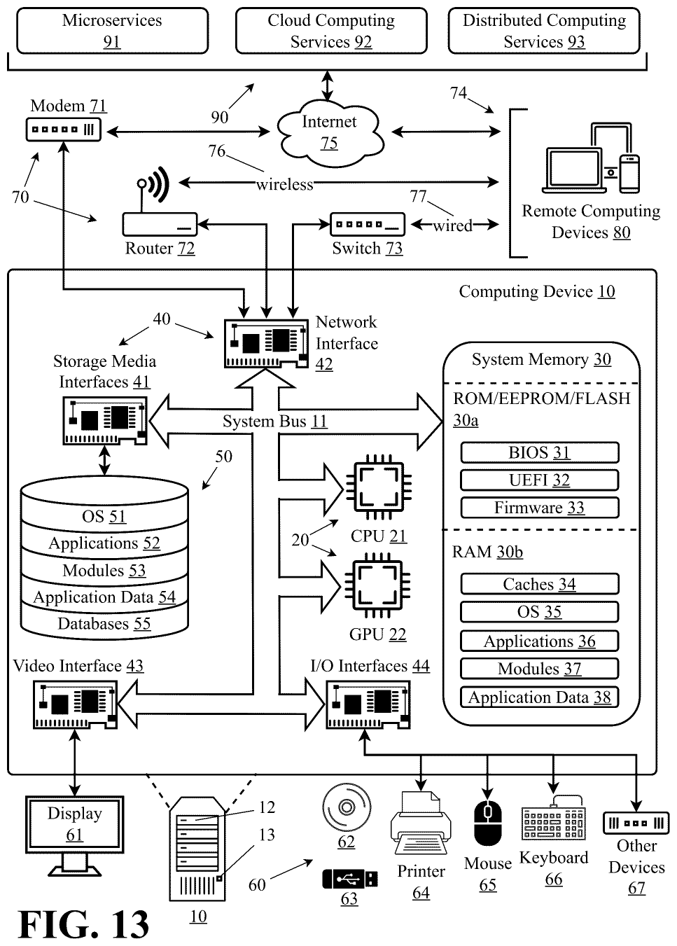

FIG. 13 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for intelligent document processing with anomaly detection and predictive analysis, comprising:
a computing device comprising a memory and a processor;
a data acquisition engine comprising a first plurality of programming instructions stored in the memory which, when operating on the processor, causes the computing device to:
receive one or more documents associated with a borrower;
feed the one or more documents into a first machine learning model comprising a convolutional neural network configured to:
normalize documents of varying dimensions using adaptive pooling;
extract multi-scale features through a plurality of convolutional layers;
apply a spatial attention mechanism to identify and weight document regions containing financial data fields; and
output document classification and associated confidence scores;
feed each of the one or more documents and its classification into a second machine learning model configured to validate the data by:
extracting data fields using classification-specific parsing patterns;
detecting anomalous values using a trained autoencoder that compares reconstruction error against learned thresholds;
performing cross-document verification by mapping relationships between related financial fields; and
generating field-level validation confidence scores;
store the validated data and confidence scores in a borrower profile; and
a generative artificial intelligence model configured to:
receive as input a query and the borrower profile including the validation confidence scores; and
generate predictive responses to the query weighted by the validation confidence scores.

2. The system of claim 1, wherein the first machine learning model is a trained classifier network.

3. The system of claim 1, wherein the second machine learning model is trained using a regression algorithm.

4. The system of claim 1, wherein the data acquisition engine is further configured to:
retrieve one or more compliance rules; and
transform the validated data to enforce compliance with the one or more compliance rules.

5. The system of claim 1, wherein the borrower profile comprises one or more access rules define one or more lender institutions which the borrower has authorized to the data in the borrower profile.

6. The system of claim 5, further comprising an application programming interface comprising a second plurality of programming instructions stored in the memory which, when operating on the processor, causes the computing device to:
transmit the validated data in the borrower profile to a loan origination system associated with the one or more authorized lender institutions.

7. A method for intelligent document processing with anomaly detection and predictive analysis, comprising the steps of:
receiving one or more documents associated with a borrower;
normalizing documents of varying dimensions using adaptive pooling;
extracting multi-scale features through a plurality of convolutional layers;
applying a spatial attention mechanism to identify and weight document regions containing financial data fields;
outputting document classification and associated confidence scores;
extracting data fields using classification-specific parsing patterns;
detecting anomalous values using a trained autoencoder that compares reconstruction error against learned thresholds;
performing cross-document verification by mapping relationships between related financial fields;
generating field-level validation confidence scores;
storing the validated data and confidence scores in a borrower profile;
receiving as input a query and the borrower profile including the validation confidence scores; and
generating predictive responses to the query weighted by the validation confidence scores.

8. The method of claim 7, wherein the plurality of convolutional layers includes three layers for three different granularities.

9. The method of claim 7, wherein the trained autoencoder is trained using a regression algorithm.

10. The method of claim 7, further comprising the steps of:
retrieving one or more compliance rules; and
transforming the validated data to enforce compliance with the one or more compliance rules.

11. The method of claim 7, wherein the borrower profile comprises one or more access rules define one or more lender institutions which the borrower has authorized to the data in the borrower profile.

12. The method of claim 11, further comprising the steps of:
using an application programming interface to transmit the validated data in the borrower profile to a loan origination system associated with one or more authorized lender institutions.
